(19) United States
(12) Patent Application Publication
(10) Pub. No.: US 2005/0006435 A1
(43) Pub. Date: Jan. 13, 2005

(54) Soldering nozzle for wave soldering printed circuit boards

(76) Inventors: Jurgen Diehm, Wertheim-Dettingen (DE); Manfred Horcher, Wertheim (DE); Markus Walter, Wertheim (DE)

Correspondence Address: BANNER & WITCOFF, 1001 G STREET N W, SUITE 1100, WASHINGTON, DC, 20001, US

(21) Appl. No.: 10/481,832

(22) PCT Filed: Jul. 1, 2002
(86) PCT No.: PCT/EP02/07246

(30) Foreign Application Priority Data
Jul. 3, 2001 (DE) 10132029.9

(51) Int. Cl. B23K 1/08

(52) U.S. Cl. 228/37

(57) ABSTRACT

The invention relates to a soldering nozzle for wave soldering printed circuit boards with electric components, which comprises rows of solder outlets arranged transversely with respect to the direction of conveyance of the printed circuit boards. Said solder outlets are arranged in a staggered manner from row to row in the direction of conveyance, whereby at least two rows are provided with solder outlets embodied in the form of slots and in each row the slots are arranged parallel to each other in a slanted position with respect to the conveyor device, whereby the slanted position of each row is reversed in relation to the direction of conveyance.

The invention relates to a solder nozzle for the wave soldering of printed-circuit boards with electrical components, said solder nozzle having rows of solder outlet openings disposed transversely to the conveying direction of the printed-circuit boards, said rows of solder outlet openings being offset with respect to each other from row to row in the conveying direction.

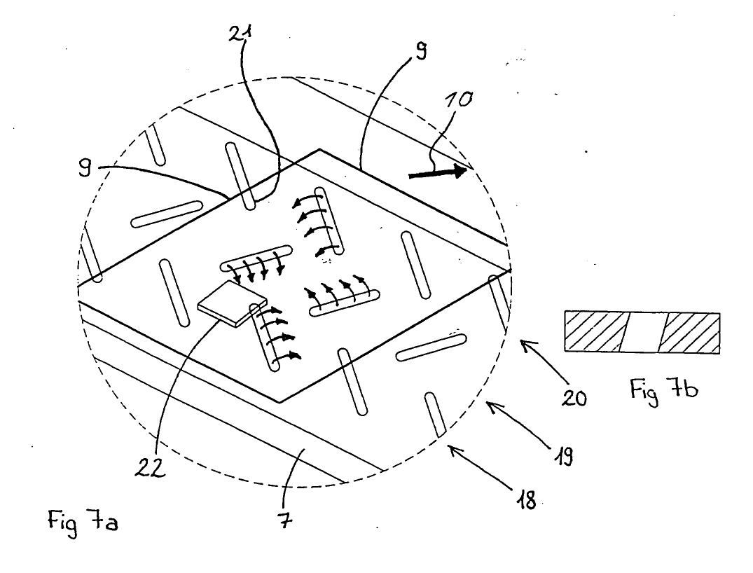

Such a solder nozzle is known from European patent application 0159424. According to FIG. 7 of said publication, said solder nozzle has two rows of round solder outlet openings. Each row is disposed perpendicularly to the conveying direction of the printed-circuit boards which are to be soldered, the solder outlet openings being offset with respect to each other from row to row. A variation on this arrangement of solder outlet openings is presented in FIG. 8 and FIG. 9 of said publication. The solder nozzles according to FIG. 8 and FIG. 9 contain, as solder outlet openings, slits which are to be viewed as connections between in each case two round solder outlet openings disposed one behind the other in the conveying direction according to the aforementioned FIG. 7, as a result of which two rows of round solder outlet openings according to FIG. 7 are replaced by one single row of slits extending at an angle with respect to the conveying direction, said angle corresponding approximately to the angle of a connection of two round solder outlet openings disposed one behind the other according to FIG. 7.

A similar design of a solder nozzle is presented in FIG. 8 of German patent specification 4329000, in which there are three rows of solder outlet openings which, similarly to the arrangement according to the aforementioned FIG. 7 of European patent application 0159425, are offset with respect to each other from row to row.

The object of the invention is to create a solder nozzle for the wave soldering of printed-circuit boards with electrical components, the solder outlet openings of which are so disposed that the connection points of the electrical components on the printed-circuit boards are particularly intensively washed around with solder. The object of the invention is achieved by a design and arrangement of solder outlet openings in which at least two rows of solder outlet openings, each in the form of slits, are provided and in which in each row the slits are disposed parallel to each other at an oblique position with respect to the conveying direction, the oblique position being reversed from row to row with respect to the conveying direction.

As viewed in the conveying direction, therefore, there results an approximately zigzag-extending succession of solder outlet openings which, according to their oblique positions, wash around with solder the connection points which face them, this being done alternately from the opposite side, with the result that there is a particularly intensive application of solder to the connection points which is effective on all sides. Consequently, the wave soldering of printed-circuit boards with this solder nozzle leads to the particularly secure soldering of all connection points which pass the solder nozzle, this being of decisive importance for the uniformly error-free production of soldered printed-circuit boards.

It is advantageous in this connection for the slits of one row to be disposed with respect to the conveying direction substantially between the following ends of the slits in the next row. This ensures that from row to row juxtaposed and adjoining regions of the printed-circuit boards are subjected to the solder supplied from the solder outlet openings.

There is a further advantageous effect on the uniform washing around with solder of the connections if, with respect to the plane of the printed-circuit board, the slits are inclined in the material of the solder nozzle in such a manner that, from row to row, there result flow directions of the solder which are directed in alternately inclined manner at the plane of the printed-circuit boards, with the result that, from row to row, there results a flow direction of the solder whose component transverse to the conveying direction runs in opposite directions from row to row.

It may be advantageous to dispose between the rows with inclined slits a row with slits aligned substantially at right angles to the plane of the printed-circuit boards. This additionally improves the washing around with solder of the connection points which are to be soldered.

Example embodiments of the invention are presented in the drawings, in which:

FIG. 1 shows the schematic representation of a wave soldering device with three rows of solder outlet openings all directed perpendicularly onto the passing printed-circuit boards;

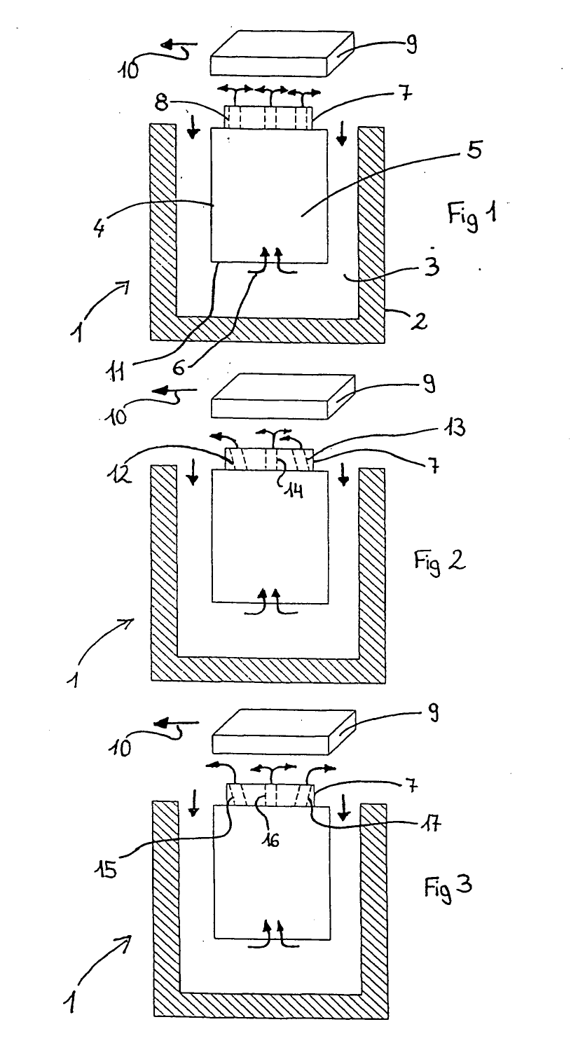

FIG. 2 shows basically the same wave soldering device with three rows of solder outlet openings, of which the two outer rows are leftwardly inclined with respect to the plane of the printed-circuit boards while the middle row is directed perpendicularly;

FIG. 3 shows likewise a wave soldering device basically the same as the devices shown in FIGS. 1 and 2, but with three rows of solder outlet openings, of which the left-hand row is leftwardly inclined, the right-hand row is rightwardly inclined and the middle row is directed perpendicularly with respect to the plane of the printed-circuit board.

The wave soldering device 1 presented in FIG. 1 consists of the container 2 (drawn in section), the interior 3 of which container 2 is filled with solder. The interior 3 further accommodates the nozzle carrier 4, which contains the hollow space into which the solder enters from the interior 3 as indicated by the arrows 6, this resulting inside the hollow space in a stable flow for the solder. This design is a known arrangement.

Affixed on the nozzle carrier 4 is the solder nozzle 7, which is penetrated by solder outlet openings 8. In this case, the solder outlet openings 8 are disposed in three rows in the solder nozzle 7, it being the case that, owing to the sectional representation, only one solder outlet opening 8 is shown. The solder outlet openings 8 extend substantially at right angles to a printed-circuit board 9 which passes the solder nozzle 7 and the underside of which is provided in known manner with the connection points which are to be soldered. In this case, the printed-circuit board 9 is drawn at a considerable distance from the solder nozzle 7, this, of course, not being the case in practice. The form of representation chosen in FIG. 1 to 3 is intended above all to illustrate the effect of the arrangement of the solder outlet openings 8, from which the solder escapes substantially perpendicularly to the plane of the printed-circuit board 9 and, after impacting on the printed-circuit board 9, flows off symmetrically with respect to the solder outlet openings 8. In order to illustrate the conveying direction of the printed-circuit board 9, the printed-circuit board 9 is drawn in a perspective view and, together with it, the arrow 1O, which indicates the conveying direction of the printed-circuit board 9. Within the wave soldering device 1, therefore, there is formed for the solder a circular movement, beginning in the interior 3 of the container 2, out of which the solder enters through the base 11 according to the arrows into the hollow space 5 of the nozzle carrier 4, from where the solder is forced through the solder outlet openings 8 by a known pump arrangement (not shown), in order, after flowing over the facing sides of the printed-circuit board 9, to flow off laterally into the interior 3, this resulting, therefore, in a corresponding number of solder waves above the solder nozzle 7.

The wave soldering device 1 presented in FIG. 2 is completely identical to that shown in FIG. 1 with regard to its basic structure, with the result that reference is made to the above explanatory remarks in relation to FIG. 1 with regard to the functions of the parts of the wave soldering device and the circulation of the solder. In contrast to the design according to FIG. 1, in the device shown in FIG. 2 the solder nozzle 7 is inclined in relation to the plane of the printed-circuit board 9, it more specifically being the case that the two outer rows of solder outlet openings 12 and 13 are leftwardly inclined in the direction of the conveying direction of the printed-circuit board 9, whereas, as in the device according to FIG. 1, the middle row of the solder outlet openings 14 is directed perpendicularly onto the plane of the printed-circuit board 9. This therefore results in a different kind of washing around with solder of the connection points on the printed-circuit board 9, this being of such design with respect to the connection points that, with regard to the rows of individual connection points, there is a succession of different directions from which the connection points are washed around with solder.

FIG. 3 shows a further variation of the design of the solder nozzle 7 in which the solder outlet openings 15 and 16 have the same inclination/vertical alignment as in FIG. 2, with the difference that the row with the solder outlet openings 17 is inclined in the opposite direction to the conveying direction of the printed-circuit board 9. As a consequence of this, when the printed-circuit board 9 passes the solder nozzle 7, the connection points are initially washed around with solder in the opposite direction to the conveying direction of the printed-circuit board 9, this being followed by a symmetrical washing around by means of the solder outlet openings 16 and by a washing around in the conveying direction by the solder outlet openings 15, this providing the guarantee in especially advantageous manner that the connection points are washed around with solder on all sides.

FIG. 4 shows a top view of the solder nozzle 7, supported by the nozzle carrier 4, with three rows 18, 19 and 20 of solder outlet openings 21 in the form of slits. Basically, therefore, the nozzle holder 7 in FIG. 4 is the same as the solder nozzles 7 shown in FIG. 1 to 3. In FIG. 4 the arrow 10 additionally indicates the conveying direction of the printed-circuit boards as they pass the solder nozzle 7, according to which the printed-circuit boards first reach the row 18 of the solder outlet opening 21, then the row 19 and finally the row 20, the connection points being correspondingly washed around with solder depending on the inclination (shown in FIG. 1 to 3) of the solder outlet openings 21 with respect to the plane of the printed-circuit boards. FIG. 4 clearly shows the design of the solder outlet openings 21 in the form of slits and their arrangement in an oblique position with respect to the conveying direction 10, i.e. with respect to the conveying direction 10 the oblique position extends from right to left in row 18, then from left to right in row 19 and finally once again from right to left in row 20, the slits in each row being parallel to each other. The solder outlet openings 21 are offset with respect to each other from row to row. This results in complete washing around with solder of a printed-circuit board, because a following row of solder outlet openings 21 basically covers that region which is not covered by the preceding row of solder outlet openings on a printed-circuit board. A certain overlapping of the solder outlet openings with the offset thereof from row to row makes it possible in this manner to achieve the reliable washing around with solder of the entire area of a printed-circuit board, it being possible, if necessary, through a variation with regard to the offset position over certain regions of a printed-circuit board, to achieve the especially intensive coverage of the printed-circuit board.

In addition to the oblique positions of the solder outlet openings 21 as shown in FIG. 4, it is, of course, also possible to have any desired inclination of the solder outlet openings 21 with respect to the plane of the printed-circuit boards, as has already been shown with reference to FIG. 1 to 3.

In order to obtain the desired effect of the reliable washing around with solder of the connection points on the printed-circuit board, it may be sufficient to employ one solder nozzle with just two rows of solder outlet openings according to the design shown in FIG. 4. The design of the solder nozzle 7 with three rows of solder outlet openings 21 is a preferred embodiment. Conversely, of course, it is also possible to use solder nozzles with four or more rows which should then be arranged according to the design shown in FIG. 4.

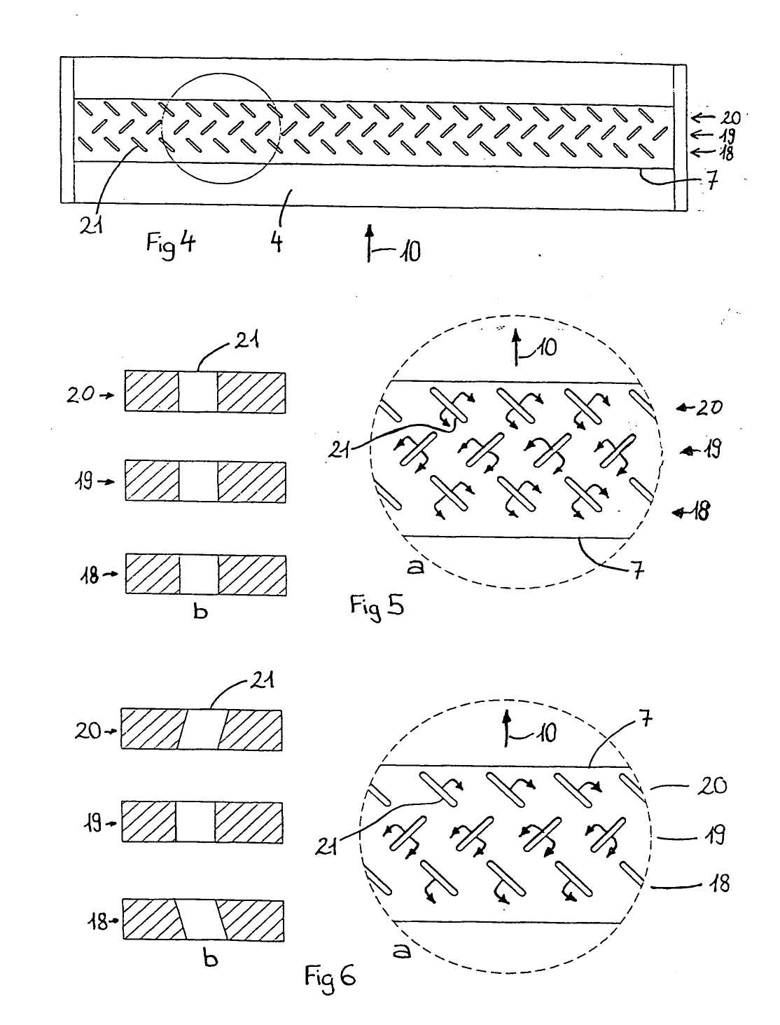

The region of the solder nozzle 7 identified by the circle drawn in FIG. 4 is presented in enlarged form, on a scale of 2:1, in FIGS. 5 and 6, once again surrounded by a broken-line circle. With regard to the oblique position of the solder outlet openings 21 with respect to the conveying direction 10, the solder nozzle 7 presented in FIGS. 5a and 6a has the same design. However, with regard to the inclination of the solder outlet openings 21 in the material of the solder nozzle 7, i.e. with regard to the alignment with respect to the plane of the printed-circuit boards, the situation is different, as presented in FIGS. 5b and 6b. The schematic sectional representations in FIGS. 5b and 6b show the respectively desired inclination of the solder outlet openings 21. According to FIG. 5b, in all three rows 18, 19 and 20 the solder outlet openings are aligned substantially at right angles to the plane of the printed-circuit board, this corresponding moreover to the representation of the wave soldering device in FIG. 1. The sectional representation in FIG. 6b shows a different inclination of the solder outlet openings 21, the inclination being from right to left in row 18, vertical in row 19 and from left to right in row 20, this corresponding to the design of the wave soldering device according to FIG. 3.

The basic direction of exit of the solder from the solder outlet openings 21 is additionally indicated by means of the arrows drawn in FIGS. 5a and 6a. According to FIG. 5a, the rows 18, 19 and 20 each have the same exit direction, namely on both sides of the solder outlet openings 21 in symmetrical manner. Conversely, the solder nozzle 7 according to FIG. 6a has a different inclination which leads in row 18 to an exit of solder opposite to the conveying direction and in row 20 to an exit in the conveying direction, for which purpose the respective arrows drawn at the solder outlet openings 21 point downwardly in row 18 and upwardly in row 20. In row 19 there is a symmetrical exit of solder because, in that row, the solder outlet openings 21 are directed at right angles to the printed-circuit boards.

In order to explain the mode of operation of the design of the solder nozzle 7 according to the invention, reference is further made to the representation in FIG. 7, which shows a perspective view of the detail of the solder nozzle 7 represented by the circle from FIG. 4. The oblique positions of the individual solder outlet openings 21 are the same as presented in connection with FIG. 4 to 6. However, with regard to the inclination of the solder outlet opening 21 in the material of the solder nozzle 7, there is, in contrast to the representation in FIG. 6, the opposite situation inasmuch as, in the arrangement in FIG. 7, a printed-circuit board 9 (represented by a thick-lined frame) first encounters the row 18 of solder outlet openings, from which the solder exits in the conveying direction of the printed-circuit board 9, thereafter both opposite to the conveying direction and also in the conveying direction and finally, in row 20, again opposite to the conveying direction. The inclinations of the solder outlet openings 21 in rows 18 to 20 are shown by the schematic sectional representation in FIG. 7b. It is therefore possible, within a row of solder outlet openings 21, to vary the inclinations of the individual solder outlet openings as required.

The printed-circuit board 9 bears the integrated circuit 22, the connection points of which are subjected successively to the solder outlet openings 21 of row 18, then of row 19 and finally of row 20. The result is the particularly intensive washing around with solder of the connection points from many directions, with the result that the connection points are soldered particularly securely.

List of reference characters
1 Soldering device
2 Container
3 Interior
4 Nozzle carrier
5 Hollow space
6 Arrows
7 Solder nozzle
8 Solder outlet opening
9 Printed-circuit board
10 Arrow, conveying direction
11 Base
12 Solder outlet opening
13 Upper solder outlet opening
14 Middle solder outlet opening
15 Solder outlet opening
16 Solder outlet opening
17 Solder outlet opening
18 Solder outlet opening
19 Solder outlet opening
20 Solder outlet opening
21 Solder outlet opening (slit)
22 Integrated circuit

1. Solder nozzle (7) for the wave soldering of printed-circuit boards (9) with electrical components, said solder nozzle (7) having rows (18, 19, 20) of solder outlet openings disposed transversely to the conveying direction (10) of the printed-circuit boards (9), said rows (18, 19, 20) of solder outlet openings being offset with respect to each other from row to row in the conveying direction, characterized in that at least two rows (18, 19, 20) of solder outlet openings, each in the form of slits (21), are provided and in each row the slits (21) are disposed parallel to each other at an oblique position with respect to the conveying direction (10), the oblique position being reversed from row to row with respect to the conveying direction (10).

2. Solder nozzle according to claim 1, characterized in that the slits (21) of one row are disposed with respect to the conveying direction substantially between the following ends of the slits of the next row.

3. Solder nozzle according to claim 1, characterized in that, with respect to the plane of the printed-circuit boards (9), the slits are inclined in the material of the solder nozzle (7) in such a manner that, from row to row, there result flow directions of the solder which are directed in alternately inclined manner at the printed-circuit boards (9), with the result that, in successive rows, there results a flow direction of the solder whose component transverse to the conveying direction (10) runs in opposite directions from row to row.

4. Solder nozzle according to claim 1, characterized in that disposed between rows with inclined slits is a row with slits aligned substantially at right angles to the plane of the printed-circuit boards (9).
